(19) United States
(12) Patent Application Publication
(10) Pub. No.: US 2016/0241807 A1
(43) Pub. Date: Aug. 18, 2016

(54) BELT SYSTEM FOR USE WITH VIDEO/AUDIO RECORDING DEVICES

(71) Applicant: Creative Law Enforcement Resources, Inc., South Pasadena, CA (US)

(72) Inventor: Kresimir Kovac, Fountain Valley, CA (US)

(21) Appl. No.: 14/620,748

(22) Filed: Feb. 12, 2015

(51) Int. Cl. H04N 5/77; H04N 5/28

(52) U.S. Cl. CPC H04N 5/77; H04N 5/28

(57) ABSTRACT

A law enforcement belt with an audio/video recording system is provided. The system includes a belt maintaining a plurality of receptacles, each receptacle configured to hold a law enforcement device, and a recording device configured to receive signals from the plurality of receptacles, the recording device configured to continuously record audio and/or video, thereby providing an audio and/or video recording. Removal of one law enforcement device from one receptacle provides a signal to the recording device interpreted by the recording device as a critical event indication, and wherein based on the critical event indication the recording device is configured to establish a prior point in time of the audio and/or video recording as a beginning of a critical event and preserve recorded audio and/or video from the beginning of the critical event to an end recording point. The system may employ wireless technology to transmit information, such as GPS location, and stream video/audio to a remote location in real time.

### BACKGROUND

I. Field

The present disclosure relates generally to the field of recording devices, and more particularly to belt systems for use in various official scenarios, such as law enforcement or military scenarios, wherein a camera device is connected to and activated by the belt system and employed to record video and/or audio information for later use.

II. Background

Many government jurisdictions are currently rolling out camera systems for use by law enforcement personnel, including police officers. Such systems are also being provided to correctional officers, military, security guards or other personnel, generally referred to herein as “officers.” The goal in using these recording devices is to obtain evidence of encounters with the public during an officer's shift for use in subsequent criminal and/or civil proceedings.

Two primary methods are currently utilized to record the actions of police officers: In-Car-Video Systems and manually activated personal recording devices. Numerous agencies have installed In-Car-Video recording systems in vehicles. These systems tend to be extremely expensive and are only effective if the activity of interest occurs within range of the police vehicle's camera and audio recording device. Additionally, significant issues can result due to maintenance and repair of fleet vehicles housing these systems.

A second method of recording law enforcement activities is to issue small audio or video recording devices to individual officers. Such camera systems are frequently body mounted, i.e. affixed to the officer's person, such as clipped to a shirt around his or her chest area, and the camera systems capture video images during various law enforcement situations. Camera systems have also been employed by military personnel in some capacity, including but not limited to helmet mounted cameras and the like. Such camera systems need to be durable and operational during critical times in particular, but can conceivably be operated at all times when an officer is on duty. A variety of potential issues arise when law enforcement personnel employ body-mounted camera devices in the field, including the potential failure of an officer to activate the camera during a critical incident, the operational failure of the camera, or the camera device capturing images not intended for public view.

Most current body worn camera recording devices typically used in law enforcement have a small internal or external memory source which is limited in capacity due to its size and inherent need to be carried either within the device or on the officer. If the body worn camera device is activated and left recording constantly, the limited memory source is quickly filled and the batteries of the device are depleted or exhausted creating the potential that critical incidents may not be recorded by the device. Such a situation would be highly undesirable as a recording of an incident could have been used at a later proceeding. Additionally if an incident is not recorded, there may be allegations of impropriety or conspiracy by the officer.

To address this, virtually all camera devices available to law enforcement personnel offer an “on/off” type switch so the officer can turn the camera recording device on and off. Because the switch enables officers to activate the device at will only during critical incidents, the memory source may not reach capacity as quickly, however, this limitation may be problematic in the field. Critical incidents are dynamic and often sudden and surprising, requiring immediate attention and full focus of the officer. In such event, an officer may be unable to activate the recording device for several seconds or minutes, failing to record the critical aspects of the incident. Officers may forget to turn on their camera recording devices for many reasons, including rapid escalation of routine contacts, injury to the officer, temporary disablement of the officer, or even simple preoccupation or inattention. In certain high stress situations it can be difficult or virtually impossible for any person to remember to turn on a recording device. Additionally, law enforcement personnel are trained to react to a threat first and then conduct administrative actions later once their safety has been assured. For example, if a suspect shoots a firearm at an officer, the officer is trained to draw and return fire as rapidly as possible in order to save his/her own life. The officer should preferably not be attempting turn on a video recording device prior to drawing their weapon and returning fire.

In order to address the above mentioned issues, an officer may wear a body worn recording device capable of transmitting video images to a remote location having larger storage capacity, such as a law enforcement vehicle nearby, or to a device on the officer's person. The equipment carried by military or law enforcement personnel must be limited in size and weight, and requiring an officer to carry a data storage device in addition to a video recording device is excessive. Alternately, a Wi-Fi, Bluetooth or cellular (commercial wireless) system may be used to transmit video images to a central location, such as a police station or other facility via an intermediate booster or transmitter located in a nearby vehicle or via a cellular tower. Problems with this arrangement include signal interruption and security. When the officer is in a location wherein such signals cannot be successfully transmitted to the nearby receiver, such as in an underground location or far from the officer's station or squad car, the signal will not be received and video images will be lost. Further, such signals may be intercepted by parties who should not have access to the images. While signal transmission security measures may help with interception issues, even minor signal losses during critical situations are unacceptable, therefore making most wireless image transmission solutions generally undesirable.

While conceptually it may be preferable to record every action of a law enforcement officer, in reality recording everything can be undesirable in a number of situations regularly encountered by law enforcement or the military. An officer whose video recording device is constantly recording may inadvertently record private citizens' confidential information. An example where this is a concern is the practice that has become known as “swatting,” where a person calls the police to say that someone is committing a crime at the residence of a famous person, the caller occasionally purporting to be the famous person. In this situation, law enforcement is summoned to the famous person's private residence. If law enforcement is recording the entire incident, he or she may record private information inside the famous person's residence. With the public having the ability to submit Freedom of Information Act (FOIA) requests to obtain public records, the “swatting” caller or even someone who heard about the “swatting” call could potentially seek to obtain the video images recorded during the “swatting” and, if successful, obtain personal and private information about the interior of the famous person's home, including contents, layout, and so forth. The same may be said of an officer recording any confidential information of any private citizen. Other mundane events, such as use of restrooms and personal conversations between officers, should not be recorded.

From a technical perspective, constant video recording throughout an eight to sixteen hour shift can create a situation where numerous batteries will be required to power the device, a significant amount of time will be needed to transmit recorded video to video storage servers, resulting in exorbitant costs to store massive amounts of video data and significant administrative management issues for the large amounts of video generated by an enterprise level law enforcement agency. Constant recording of video footage by law enforcement personnel, or in other words the inability to turn off video image recording, is therefore a significant potential problem.

A number of devices are available that incorporate a camera designed to be carried on the body of a law enforcement officer. These cameras include, but are not limited to combination cameras attached to Taser devices (sold by Taser International, Inc.), cameras incorporated into flashlights, cameras provided with firearms, and so forth. The problem with all of these is the same as described above, the inability to record what happened before the Taser, firearm, flashlight, etc. was deployed, and worse than a body mounted camera, these devices must be deployed and engaged to record the incident. In some instances the scenario can unnecessarily escalate. For example, a belligerent suspect may become violent if a gun barrel with a camera is pointed at him, albeit merely to record the situation. Also, if the officer needs to use his or her weapon but must also pull out, for example, a flashlight with an attached camera in order to record an event, such requirements are undesirably cumbersome and in many cases will not be achieved. In such critical scenarios, it is likely that officers will fail to effectively deploy equipment, including the recording device.

It would be highly beneficial to offer a system wherein the issues related to video and audio recording by individuals such as law enforcement, military and security personnel are minimized or eliminated. An intuitive system that is activated in critical incidents without specific thought or intention on behalf of the officer, and one that does not require significant additional equipment to be carried or maintained would be desirable.

### SUMMARY

According to the present design, there is provided a recording apparatus, including a recording device configured to continuously record audio and/or video, thereby providing an audio and/or video recording, and a belt provided with a plurality of receptacles, each receptacle provided with the belt configured to hold a device, wherein the plurality of receptacles are electrically connected to the recording device. Altering status of one device in one receptacle provided with the belt causes an indication to be transmitted to the recording device, and wherein upon receiving the indication the recording device is configured to establish a prior point in time of the audio and/or video recording as a beginning of a critical event and preserve recorded audio and/or video from the beginning of the critical event to an end recording point.

According to another aspect of the present design, there is provided a recording apparatus, including a belt provided with a plurality of receptacles, each receptacle provided with the belt configured to hold a device comprising at least one from the group comprising a law enforcement device, a security device, and a military device, and a recording device configured to receive signals from the plurality of receptacles, the recording device configured to continuously record audio and/or video, thereby providing an audio and/or video recording. Altering status of one device in one receptacle provided with the belt causes a critical event indication to be sensed by the recording device, and wherein based on the critical event indication the recording device is configured to establish a prior point in time of the audio and/or video recording as a beginning of a critical event and preserve recorded audio and/or video from the beginning of the critical event to an end recording point. The design may include a recording buffer function wherein the recorded event is retained prior to the point in time in which the device was activated.

According to a further aspect of the present design, there is provided a law enforcement belt system, including a belt maintaining a plurality of receptacles, each receptacle configured to hold a law enforcement device, and a recording device configured to receive signals from the plurality of receptacles, the recording device configured to continuously record audio and/or video, thereby providing an audio and/or video recording. Removal of one law enforcement device from one receptacle provides a signal to the recording device interpreted by the recording device as a critical event indication, and wherein based on the critical event indication the recording device is configured to establish a prior point in time of the audio and/or video recording as a beginning of a critical event and preserve recorded audio and/or video from the beginning of the critical event to an end recording point.

Various aspects and features of the disclosure are described in further detail below.

### BRIEF DESCRIPTION OF THE DRAWINGS

FIG. 1 shows an example of an existing police belt or officer's belt, including devices and receptacles;

FIG. 2 is a conceptual representation of the present system;

FIGS. 3A, 3B, 3C, and 3D show recording representations in various scenarios using the processing/recording device of the present design;

FIG. 4 shows tape having flat wires provided therewith that may be employed with the present design;

FIG. 5 illustrates interconnections using the tape including wires between various belt receptacles and the processing/recording device;

FIG. 6 is a representation of the processing/recording device; and

FIG. 7 illustrates operation of the present design in conjunction with various modes of communication.

### DETAILED DESCRIPTION

The present design enables law enforcement, military, security officers or other appropriate personnel to automatically record (audio and/or video) evidence, within their presence, without the need to manually or consciously initiate the recording, such as during situations where the individual is under stress. The recording system has the ability to automatically preserve video/audio images of the officer's actions from a time prior to occurrence of a critical event at times when he/she is in the performance of his/her duties as an officer.

The belt acts as the backbone for a holistic system in which cameras, activation mechanisms, monitoring systems, recording devices, GPS, commercial wireless, Wi-Fi, etc. are integrated into an electronic device capable of managing the system, recording audio/video, transmitting/receiving/storing data among other capabilities.

As used herein, various terms are employed and are intended to be used in the broadest sense possible. For example, the present application uses the term “officer” or “law enforcement officer” or otherwise to indicate the individual employing the system, and such a term is meant to broadly encompass any individual who may have use for such a device or system, including but not limited to police officers, military personnel, corrections officers, security personnel, or other interested individuals. Additionally, contents of the belt described herein may differ, and different officers may employ different equipment. The officer may employ a holster that holds a handgun, a receptacle for a nightstick, handcuffs, radio, OC spray, a light source such as a flashlight, and a control device, but any type of appropriate item, such as an item utilized by law enforcement, security, or military officers may be employed. Different devices may be used to record video and/or audio images, and/or store and transmit these video/audio images. With respect to recording devices, the term “camera device” is intended broadly to mean any type of recording device, typically a video and audio recording body mounted device, a video only body mounted device, or an audio device. These are collectively referred to herein as a “recording device.” Further, certain devices are described herein as being a single device while others are described as multiple devices, and it is to be understood that the invention is not limited to the devices described but single or multiple devices may be employed where multiple and single devices, respectively, are described, as long as the functionality described is performed. The foregoing and other concepts disclosed herein are intended to be interpreted broadly and not limit the scope of the present invention.

A prominent part of the present design is a variation of a standard police duty belt currently worn by virtually every police officer on duty in the United States. The police duty belt is worn around the waist of the law enforcement officer over a secondary inner belt, typically looped through the belt loops of the officer's pants. The duty belt contains various pouches and holsters which secure various items of police equipment to the officer's waist. This equipment includes but is not limited to a handgun, ammunition, a police radio, a police baton, OC spray, handcuffs, a recording device, a flashlight, and in certain instances other types of devices. Generally, the pouches and holsters on the outer police duty belt are attached and not removed unless the officer wishes to modify their contents or provide a pouch or holster with a different function.

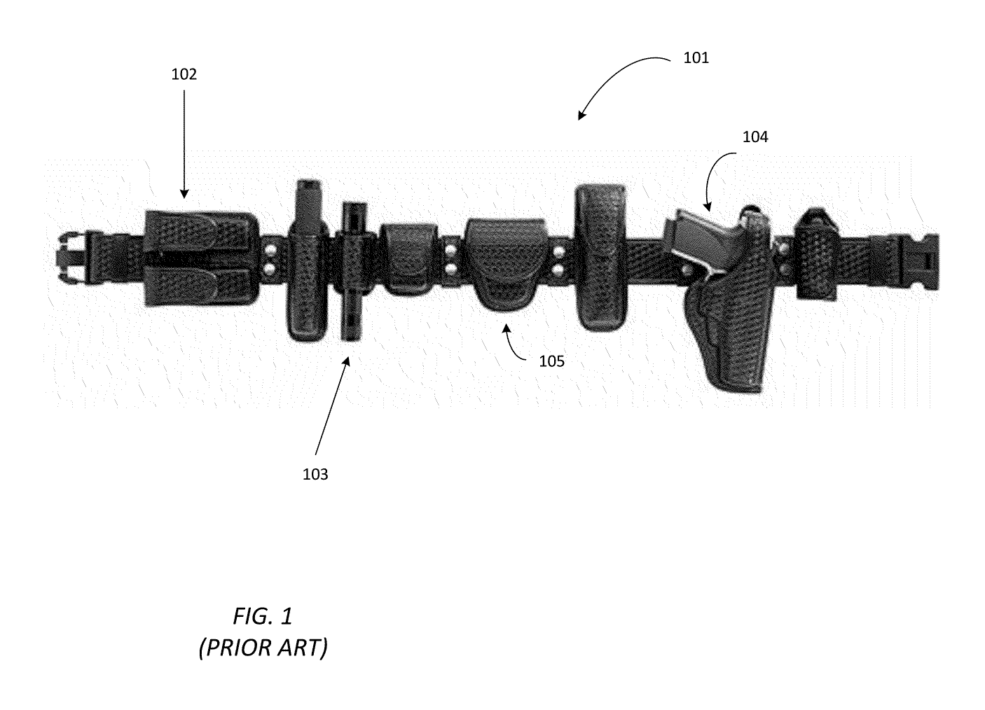

FIG. 1 illustrates one example of a standard police belt. Other devices may be adapted in accordance with the present design to operate in conjunction with a recording device as disclosed herein. Each of the above listed items is secured in a holster or pouch which is firmly attached, via a belt loop, to the outer duty belt or belt 101. Each pouch or holster typically utilizes a metal snap closure attached to a synthetic flap to secure the item inside the pouch. This flap or snap is generally part of some type of security retention system designed to securely hold the item of equipment on the belt until the officer deploys the item.

In order to remove an item from a pouch or holster, the officer must first unsnap the security flap, snap, strap, clasp or other retention system in order to remove the item. An example would be an officer unsnapping the retention strap on his/her handgun holster prior to drawing the firearm. The duty belt 101 may be constructed of different materials, including one or more layers of leather, with leather pouches or holsters. Other materials may be employed, such as nylon, plastic, Kydex, laminates, etc., and belts may be constructed of more than one type of primary material.

FIG. 1 illustrates various official devices and receptacles used in one instance of a duty belt 101, with devices including ammunition 102, flashlight 103, handgun 104, and handcuffs 105. The present system provides an interface between the duty belt 101 and the various pouches and holsters on the belt which enclose an assortment of items and equipment. This interface electronically connects a recording device to the duty belt and the various pouches and holsters provided with the duty belt. When an officer intends to deploy an item of equipment, he/she first unsnaps the security flap/retention system of the pouch holding the item. This unsnapping action is a signal, called herein a “critical event signal” or “critical event indication,” indicating the recording device should initiate with no further action required from the officer. In the belt arrangement shown in FIG. 1, the officer's gear (handgun, electroshock weapon, OC Spray, baton, etc.) is secured and cannot be deployed without first unsnapping the retention snap. The present design employs this attribute, i.e. unsnapping the retention snap is a critical event signal or indication causing the recording device arrangement to function in a desired manner and preserve desired video and/or audio. As a result, a video/audio recording is initiated as the officer makes the decision to deploy a handgun, baton, OC spray or handcuffs, or other desired belt component or holstered device, without the separate activation of the recording device. Other actions can be considered a critical event signal as described herein. Additionally, there may some equipment carried in a pouch or device with no retention system (such as a baton). In such a case, a mechanism may be provided in or with the pouch that activates the recording device once the equipment is drawn or deployed. A simple switch or other method or means may be incorporated into the pouch or belt in order to accomplish this functionality.

The recording arrangement, such as a recording device and a storage device, is configured with a buffer or loop and the recording device is configured to continuously record audio and video and discard unmarked or unidentified audio or video. The audio recording can be considered a first in, first out buffer or circular buffer arrangement wherein portions are periodically discarded while new audio or video is recorded. Size of the buffer depends on the equipment employed, i.e. the size of the storage employed, quality of video or audio desired, administrative settings on the device, and decisions of appropriate personnel. As an example, a thirty second buffer, a five minute buffer, or a buffer of any other desired time period may be employed. Different buffer time standards may be provided depending on the item of equipment activating the recording device.

When, for example, an officer unsnaps his/her handgun holster, a critical event signal is sent to the recording device and the recording device marks the time of the indication and also marks the point a fixed time prior to the critical event signal and saves and does not discard video or audio obtained between the marked point (e.g. one minute before) and the critical event signal, i.e. the officer unsnapping his/her holster, and continues to record until the officer stops the device or the maximum recording time allowable is reached. While recording, the recording device may discard unnecessary, i.e. unmarked, recordings to increase capacity.

Thus each time a peace officer unsnaps the retention device to deploy an item of police equipment from his/her duty belt (or draws the equipment if there is no overt retention system), the incident and events during a period of time preceding the critical event signal, as well as the period of time immediately following activation of the recording device are captured on video/audio. Recording is initiated automatically in the course of normal officer duties and actions, without additional conscious thought or effort on part of the officer, and is typically limited to periods when the officer is engaged in significant police action or a critical event (i.e. arrest, use of force, officer involved shooting, etc.). As the officer and his/her employing agency are at the greatest liability risk during these critical incidents, such a recording of the incident has significant evidentiary value and can reduce this liability burden.

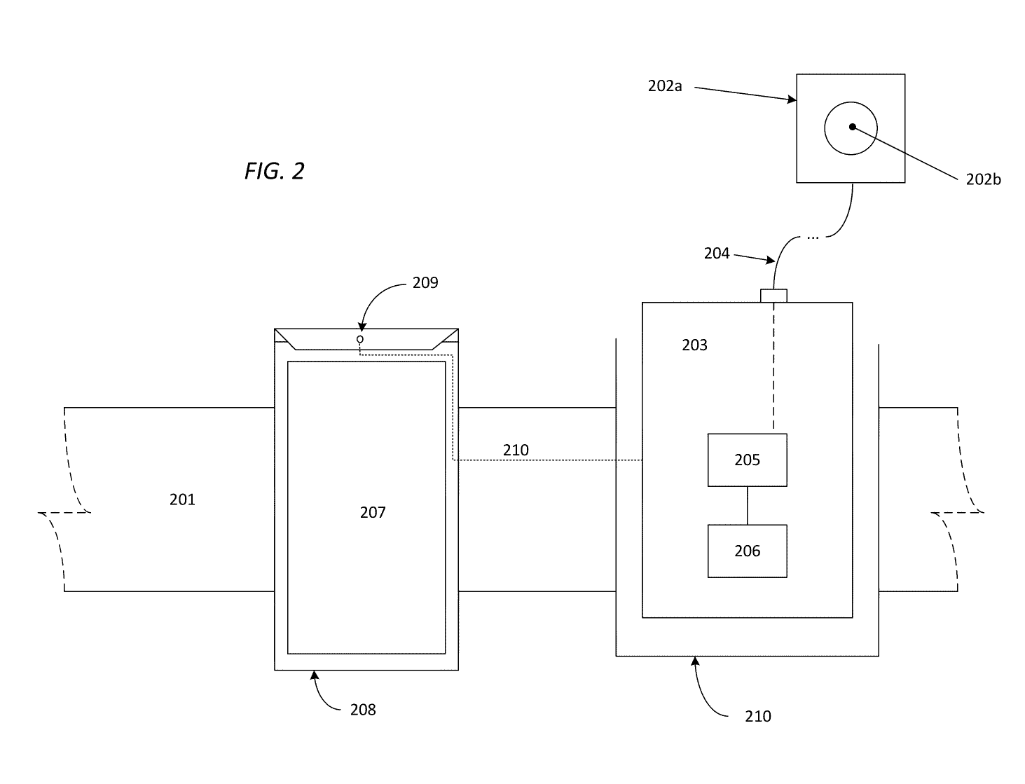

The present design is conceptually shown in FIG. 2. From FIG. 2, there is provided a police belt 201, a recording device 202a configured to be located on the officer's person and record video and/or audio images, including a sensor 202b in this embodiment. Signals are transmitted to a processing/storage device 203 such as by the wire 204 shown or wirelessly. Wireless transmission requires a transmitter connected to or provided with the recording device and a remote receiver connected to or providing signals to the processing/storage device 203 as described herein. Any of these components may be integrally formed in a single housing or may be separate components.

Processing/storage device 203, also representing a recording device, may include a processor 205, a storage device 206, and the processor 205 may be configured to perform the functions provided herein and other relevant functions. Processing/storage device 203 may be integrated into police belt 201 or may be provided separately with a separate storage compartment or holster provided on the police belt 201. Storage compartment/holster 211 is shown in this embodiment. Also shown in FIG. 2 is a holstered item 207, which may be a gun, for example, but any of the aforementioned devices, contained within a holster 208. Holster 208 includes a retention snap 209, and retention snap 209 is electrically connected in this embodiment to processing/storage device 203. A wireless connection or other appropriate connection may be provided at a point between retention snap 209 and processing/storage device 203. Electrical connection to retention snap 209 may be using any known means, including providing a small current through or voltage across the retention snap 209 such that the snap acts as a switch, providing a signal or value when closed and a different signal or value when open. Processing/storage device 203 may provide other functionality, such as monitoring noise levels to detect gunshots, and so forth. Although not shown in this view, one or both of processing/storage device 203 and recording device 202a may be provided with a switch (not shown) able to turn on and off recording of desired incidents.

While shown as a snap device, retention snap 209 may be any type of retention mechanism or means and may take other forms, such as a conductive strip or piece, a motion sensor in the holster 208, a light sensor in the holster 208 that senses a change in light received, such as when a holstered item is removed from the holster 208. Alternately, the design may include other means for establishing a critical event, such as a safety strip that operates so that removal of the holstered item 207 tears or otherwise compromises the strip, and compromise of the strip can be sensed indicating a critical event has occurred. Any other device or sensor or apparatus that can be used to determine the holster 208 has been opened and/or holstered item 207 has been removed may be employed.

When the system senses that holster 208 has been opened and/or holstered item 207 has been removed, an electrical signal is provided to processing/storage device 203, such as via line 210, and processing/storage device 203 senses the signal and determines that the holster 208 has been opened and/or holstered item 207 has been removed. Such an indication is a critical event signal, and upon sensing a critical event signal, processing/storage device 203 performs audio/video processing as described below.

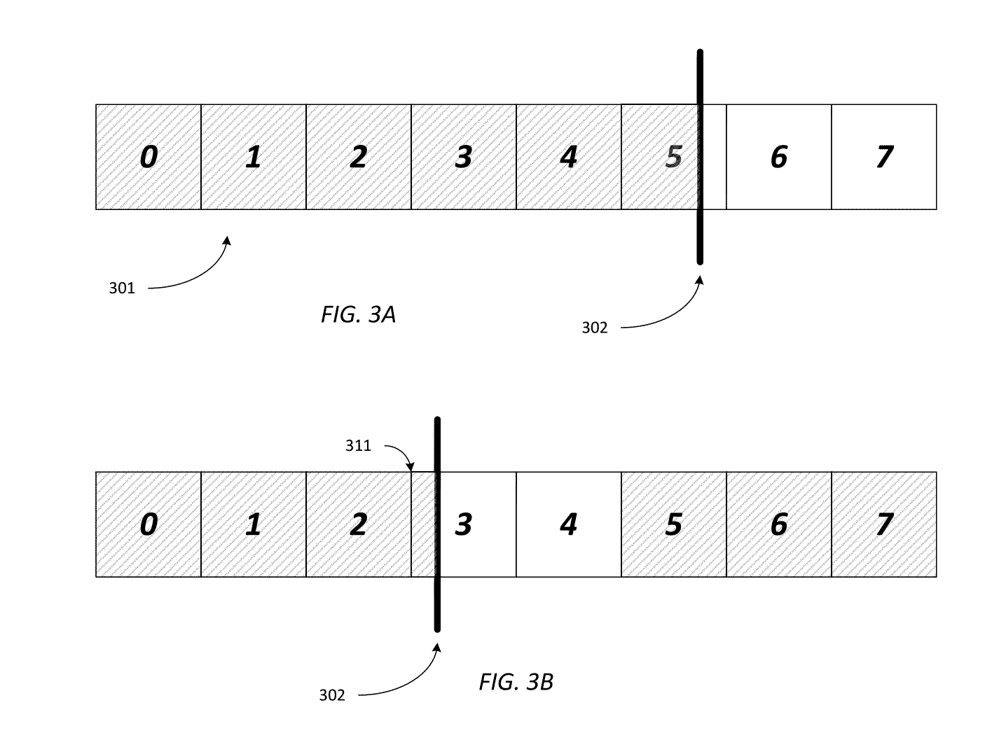

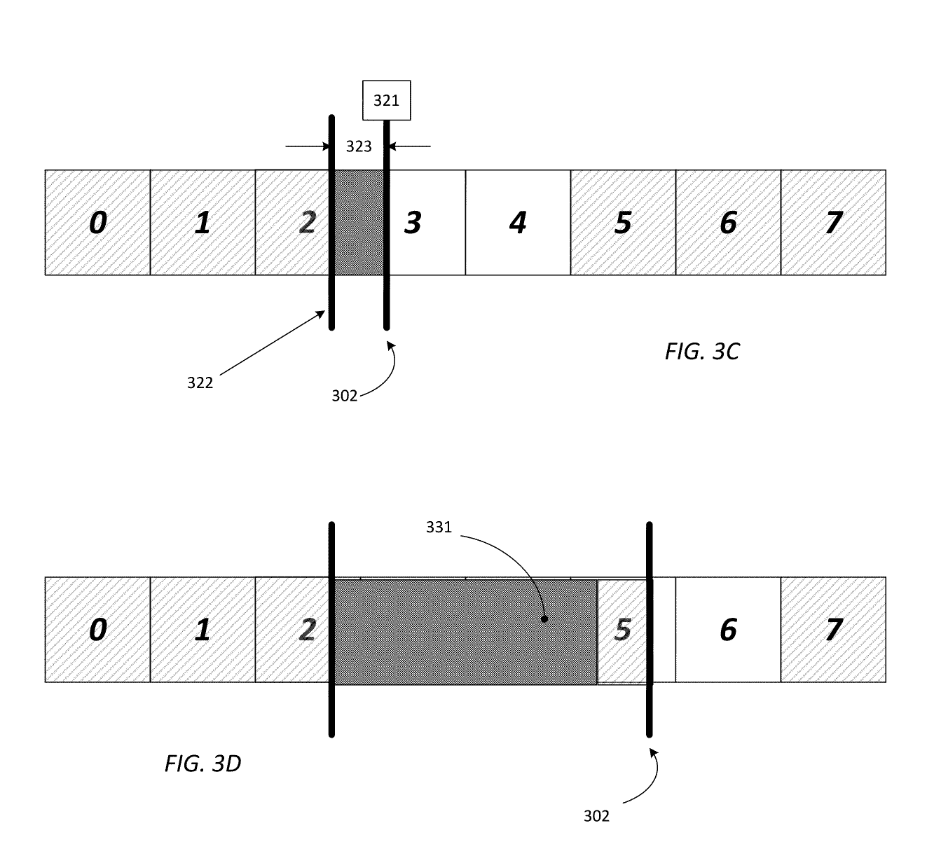

Various embodiments of critical event signal and buffer operation are illustrated in FIGS. 3A, 3B, 3C, and 3D. FIG. 3A shows the buffer 301 partially filled, where the recording device 202 and the processing/storage device 203 have been operating for a period of time, the period of time less than the time needed to completely fill the buffer 301. Buffer 301 in this view is divided into eight sections numbered 0 through 7. If the buffer 301 could accommodate one hour of combined video and audio recording, FIG. 3A illustrates less than one hour of recorded video and/or audio images, such as approximately 35 or 40 minutes in this embodiment. Other buffer sizes and region sizes may be provided. Present time 302 is shown, and buffer regions 0, 1, 2, 3, and 4 are full, while buffer regions 6 and 7 are empty. Buffer region 5 is partially full and partially empty.

FIG. 3B shows buffer 301 where the buffer 301 is again partially full, but the recording device 202 and the processing/storage device 203 have been operating for a period of time greater than the time needed to completely fill the buffer 301. In this embodiment, present time 302 is in buffer region 3, buffer region 4 is empty, and all other buffers are filled with previously recorded video and/or audio recordings. In one embodiment, the buffer cycles from buffer region 7 to buffer region 0 as current time progresses from buffer region 7 to a next buffer, i.e. the buffer 301 is circular or operates as a circular buffer. Other buffer designs may be employed. In this embodiment, when current time 302 passes a buffer region border, the system clears the next subsequent buffer region. In this example, when current time 302 passes buffer region 3 initial border 311, the system clears out buffer region 4. In this manner, one buffer region is emptied at the time the preceding buffer region begins to fill. Other implementations may be realized wherein space in buffer 301 is made available on a continuing basis and past video and/or audio data is maintained in an ongoing basis.

FIG. 3C illustrates system operation in the case of receipt of a critical event signal. Present time 302 is shown, and at present time 302 critical event signal 321 is received. Buffer region 4 is empty. Processing/storage device 203 identifies preceding time point 322 and marks preceding time point 322, where time period 323 represents a predetermined amount of time between receipt of the critical event signal and the desired beginning of the video and/or audio information to be saved. From that point until recording device is turned off and/or the processing/storage device 203 is turned off, such as by the officer, the processor/storage device 203 continues to record and store video and and/or audio.

As may be appreciated, certain issues can occur, including the storage filling up. Some interactions can last for lengthy periods of time, even hours. Additionally, in a fistfight or other scuffle, one of the devices in FIG. 2 can be disabled, broken, disconnected, or otherwise rendered ineffective. In the case of an extended or lengthy incident, the processing/storage device may provide a warning or may operate at a reduced fidelity, such that a lower quality video and/or audio record is maintained after a period of time to preserve as much evidence as possible. As an example, the processing/storage device 203 may switch to a low fidelity video recording mode when buffer 301 is 75% full. One method is to record video and audio every other second, or transitioning from X frames per second to 0.5X frames per second.

Again, recording continues until the officer turns off the recording such as via an included hardware or software switch. Once the recording has been turned off, after such an event, the officer may complete his shift and turn his or her device in for processing. Processing in this context includes downloading, transferring, or offloading the video and/or audio data to a central storage location or device. In other situations, if a large enough storage device is available, the officer may be able to record more than one critical event during a single shift. In this situation, the representation of FIG. 3C may include two or more critical event signals and two or more periods of time wherein the processing/storage device 203 is recording video and/or audio.

If enough recording time is available for the officer to continue performing his or her duties, one example of which is shown in FIG. 3D, the (first) incident 331 is preserved, recording resumes and is ongoing after the officer has ended incident 331, and recording proceeds in a loop bypassing instance 331. Critical event processing may occur as described above with accommodations made to not erase or “tape over” incident 331. Note that in any of these scenarios depicted in FIGS. 3A through 3D, the amount of available time may be provided to the officer, such as via display on a screen of the processing/storage device 203.

The present system may employ security features to inhibit tampering with the recordings by an officer. In one instance, an officer may employ excessive force and may fear discipline as a result of his or her use of excessive force. The officer may attempt to tamper with the recording of the incident, by taping over or otherwise destroying the video and/or audio of the incident. The present design may, for example, provide a marking (date and time), random number, or other indication whenever a critical incident occurs, such as an indication that is not displayed with or otherwise provided with the video footage and cannot be erased or altered except by a different (official) device or by using a particular code. Any other indicator that cannot be erased or deleted by the officer may be employed and/or provided. Additional security safeguards may be incorporated such as watermarks or other methods to identify and inhibit tampering of recorded evidence either on the recording device or once downloaded onto a storage system.

Thus the present design, and more particularly the processing/storage device 203, performs functions including but not limited to audio recording using a microphone, the recording buffer capability described above, a manual slide activation switch, automatic activation as described above, play, rewind and fast forward functions. Functions and buttons (hard or soft) may be provided to effectuate a file function, bookmark function, and/or folder function. An override off switch may be provided. A display screen and an activation indication, such as a light, may be provided, as well as an audio speaker plug and/or audio microphone plug. The unit may employ a rechargeable battery, removable media (e.g. SD card), and as noted information may be transferred or downloaded to a separate central drive or a removable drive such as a CD or DVD. The device may produce video and/or audio compatible with existing formats, e.g. Windows Media Player or QuickTime. The device may also utilize an affirmative notification feature in which a sound, light and/or vibration is used to notify the officer when the system is activated thereby ensuring the system never activates without the officers knowledge.

The processing/storage device 203 may also include digital video recording capability in the form of a separate video recording apparatus (miniature video camera). The system, including the recording device 202, may include a video camera incorporated into a standard police radio handset, a video camera clipped onto a radio handset, a video camera incorporated into the belt 201, and/or a video camera clipped onto the shirt, pocket or other part of the officer's uniform.

The system may utilize a camera incorporated into the processing/storage device 203 and a secondary external camera mounted somewhere on the officer's body. The system, when activated, may initiate both cameras simultaneously to provide different views of an incident or may only active one camera as predefined by the user/administrator. In such a case, the system could be set up to automatically turn on the second camera in the event the primary camera is disabled (e.g. fight, wires pulled from camera body, etc.). Thus the system may incorporate more than one video camera or more than one audio microphone. A camera may be incorporated into the body of the processor 203 or other device worn on the duty belt 201. A secondary camera may be attached on another part of the officer's body or belt system 201 to provide an opposing secondary view of an incident. Additionally, the integration of a secondary camera, connected via a wired or wireless method, would help ensure the recording is not completely disabled during a struggle/fight with a suspect whereby the primary camera is ripped from the device or disabled due to damage (e.g. blow, kick, crushed). The system may be configured so that only one camera is operational during normal recording activations; however, both cameras may be activated when a handgun or baton are deployed.

The processing/storage device 203 may include functionality such as acoustic gunshot activation and/or a directional acoustic gunshot detector. The processing/storage device 203 may employ a diagnostics/self-test feature, a built-in external speaker, a built-in playback screen, an external/plug-in microphone, an On/Off switch to shut off all recorder functions, and/or a lockable recorder memory medium access door. The system may employ RFID devices implanted in pouches and holsters, and a police car mobile digital computer (MDC) may interface with the processing/storage device 203. RFID, WiFi, Bluetooth or other wireless connectivity may be provided between the present system and a police vehicle and/or a police radio.

A vibratory feature may be provided within the system, such as in the processing/storage device 203, or via a separate device, such as to notify the officer that the device is recording, or not recording, or full, or any other beneficial function in a covert manner. Such vibratory functionality may be provided by a separate device, possibly independently powered. The system may be configured so that when the recorder activates, a one second vibration is felt by the officer to covertly notify him the system has activated. Other vibratory notifications (e.g. sporadic vibration, one half second vibration, etc.) may be incorporated to advise the officer of other functions or notifications. The vibratory function may be provided as an option and may be incorporated into the processor, camera or some other type of device located on the person of the officer.

Also provided may be a command center alert override button or switch to override alerts to the Command Center when the device is triggered, a USB plug interface, docking cradle, programmable recorder controls, ability to provide a Wi-Fi hotspot and/or Wi-Fi connectivity, Wi-Fi Time Synch, and commercial wireless service may be provided. It may be understood that an existing smartphone may be modified or employed to perform some, many or all of the functions required of or optionally offered with the processing/storage device 203.

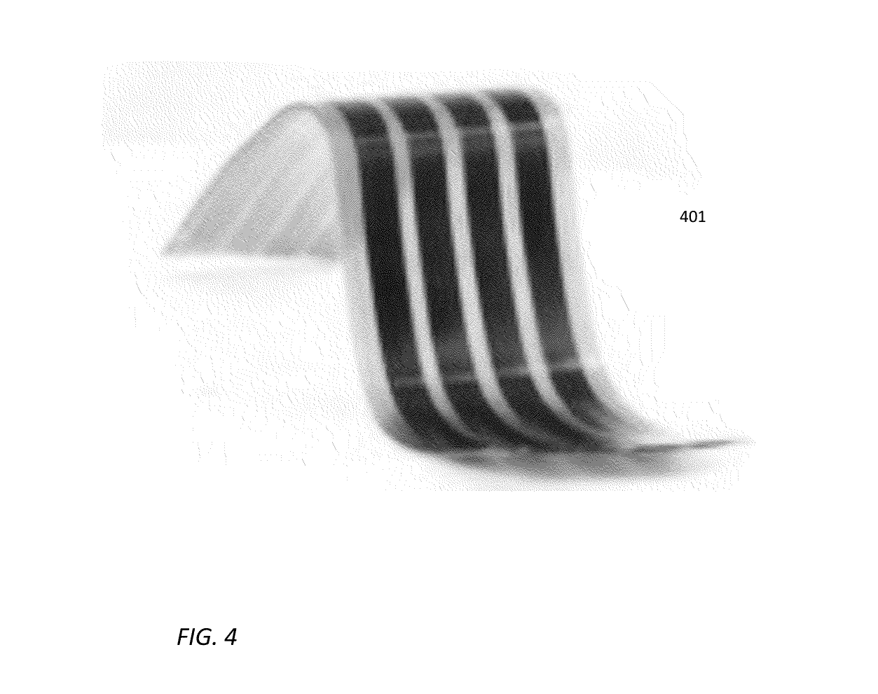

With respect to the belt 201, several pieces of nylon have in the past been sewn, glued and pressed together to form the duty belt. A thin circuit tape 401, such as is shown in FIG. 4, can be provided with, e.g. sewn into, the belt. The circuit tape 401 can possess multiple individual electrical lines/leads running through it. The circuit tape 401 is sewn into, fixedly mounted within or outside of the belt and may not be visible once the belt is assembled.

In one aspect, belt 201 may have metal grommets or similar items embedded in its inside portion. The metal grommets may be threaded so that a small screw or bolt can be screwed into the center of the grommet. Each pouch or holster has two small metal grommets on the rear loop (not threaded). Each pouch is slid on the duty belt via the loop and placed in the appropriate location on the belt. Small screws or bolts are provided through or to the metal grommets on the pouch loop and into the threaded grommets on the duty belt. This secures the pouch into the designated location on the duty belt. Two grommets are provided on the pouch or holster loop. An embedded wire runs from each pouch loop grommet to each end of the metal snap which is utilized to secure the pouch flap on the pouch or holster. The screws or bolts screwed through the grommets on the pouch and into the grommets on the duty belt extend far enough into the duty belt so that they contact a designated lead on the circuit tape embedded inside the belt. This implementation creates a circuit that can be utilized by the system. When the holster or pouch is snapped closed, a complete circuit results. Unsnapping the holster or pouch breaks the circuit and activates the processing/storage device 203 which would also be connected to the system in a similar fashion. Each style of pouch (holster, handcuff pouch, OC spray pouch, electroshock weapon holster, baton holder) has grommets embedded or connected at a different height on the belt 201. Different height positions cause the different devices to always utilize different leads/wires on the circuit tape, enabling processing/storage device 203 to recognize which pouch has activated the recording device. The belt 201 has a number of grommets embedded in the inner portion of the belt 201, throughout its length, enabling each officer to position equipment pouches and holsters in locations that are the most comfortable and efficient.

Alternately, circuit tape may be affixed, such as sewn, into the length of belt 201 as noted above. In this embodiment, grommets or the like are not provided in the inner portion of the belt. Each pouch or holster possesses a standard belt loop that slides onto and secures the pouch or holster to the belt 201. An additional metal hasp or similar device is affixed to the back of the pouch or holster. Once the pouch or holster is slid onto the belt 201, the metal hasp or similar device is closed over the back of the belt 201 and secured. The metal hasp may include two pins that puncture through the outer material (on the inside of belt 201) and connect into the circuit tape within belt 201, creating a circuit. The metal pins of different types of pouches or holsters may be positioned at different locations on the metal hasp to ensure different circuits are utilized on the belt 201.

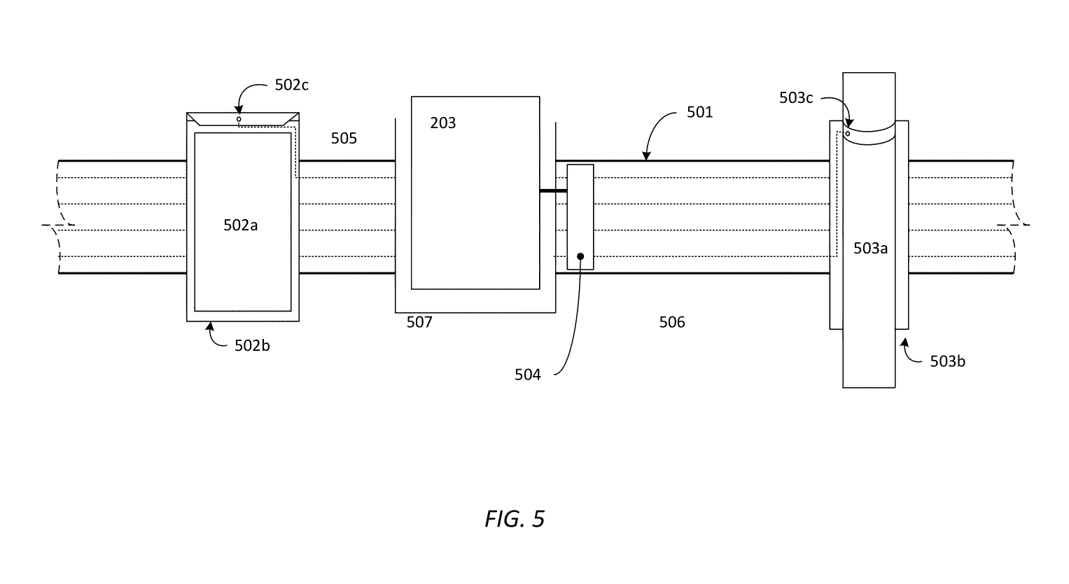

FIG. 5 illustrates the general use of thin circuit tape 401 or similar which may be sewn into belt 501. Two devices and two receptacles are shown in FIG. 5, device 502a and receptacle 502b, and device 503a and receptacle 503b. Electrical connections, such as grommets, snaps, or other appropriate devices are shown as electrical connections 502c and 503c. Processing/recording device 203 is shown, and in this view intermediate device 504 is provided, wherein intermediate device may be a transformer, signal booster, multiplexing cable, or any other intermediate device that facilitates providing electrical connections and indications from the receptacles and their components or connections to processing/recording device 203. A direct connection, without intermediate device 504 may be provided. From FIG. 5, receptacle 502b connects to wire 505 using electrical connection 502c, while receptacle 503b connects to wire 506 using electrical connection 503c, and wires 505 and 506 in this embodiment connect to intermediate device 504, which connects to processing/recording device 203, here housed in receptacle 507. Other implementations are possible, such as two or more receptacles using a single wire such that removal of any device constitutes a critical event and the processing/recording device 203 senses that a critical event has occurred. Such an implementation may not be able to record and/or document which device was removed from its receptacle. While a limited number of electrical lines are shown in FIG. 5, any number of lines may be provided, with some lines not employed to make an electrical connection. Additionally, different electrical lines maybe utilized by different types of pouches or holsters. This would allow the system to know which item is being deployed based on the electrical lines (circuits) being broken or activated.

The processing/storage device 203, able to record audio and/or video, may sit or be seated inside a dedicated pouch designed for the device. Inside the bottom of the processing/storage device pouch may be a “male” electronic interface plug, while the bottom of the recorder body may have a “female” electronic interface plug which mates with the “male” plug in the pouch.

The processing/storage device pouch is secured to the duty belt via a loop. The processing/storage device pouch loop may have a large dedicated oblong grommet. Once small screws/bolts secure the loop to the belt 201, the processing/storage device pouch forms a circuit with the other pouches and holsters on the belt 201. When the processing/storage device is placed inside the processing/storage device pouch/enclosure, it interfaces with the belt, pouches and holster via the electronic interface plug. The processing/storage device pouch holder may be waterproof and provide substantial protection to the processing/storage device 203. Basic functions can be activated while the processing/storage device is in its pouch, including but not limited to the activation of the slide switch (to initiate manual recordings), and bookmark and index button functions.

Generally the processing/storage device 203 may be positioned on an outer surface of belt 201 near the center of the body. The processing/storage device 203 may be activated by the officer manually with either hand. The processing/storage device 203 may be a mini computer having a shape and style similar to a smartphone or may be an actual smartphone. Additional capabilities and components can be integrated using such a device (GPS, remote listening, etc.). All actions and triggers can be date/time stamped and recorded via the processing/storage device 203. A smartphone style device typically includes a large LCD screen that may be used for reviewing video and checking the functionality and settings of the device. Such a device can be upgraded and reconfigured depending on needs and requirements.

The processing/storage device 203 has digital audio recorder capability. Digital audio recorders can retain/record several days of recorded material, versus small cassette recorders which may have a maximum of, for example, 15 minutes of recording time. Digital audio recorders can download their recorded material onto a CD or directly to a digital storage medium eliminating the need to purchase and store costly analog tapes. Significant recorded incidences can also be quickly copied and e-mailed in native or compressed digital format.

As noted, processing/storage device 203 is constantly recording and erasing audio and/or video. The device can be set to constantly record and retain recordings for almost any reasonable period of time, such as from 5 seconds to 5 minutes, a time value that can be modified by a computer system administrator. Once a pouch is unsnapped or a manual recording is initiated (critical event) as described herein, the processing/storage device 203 immediately saves the previous X seconds of recorded footage and begins recording in “live time.” This will not only allow an incident to be recorded but also save the preceding X seconds prior to the recorder being activated. This capability may be disabled so that the device only activates once something is triggered (equipment deployed) or manually activated. At that point the device activates and records until shut off.

An officer may be able to activate the recording device manually. There will be times when an officer comes into contact with a citizen and wishes to record the incident surreptitiously even though an arrest is not made and no force is utilized. These incidents can include a traffic stop, contacting a victim, confession by a suspect, etc. A recorded contact will additionally protect the officer from false allegations or complaints.

The processing/storage device 203 may include a slide activation switch. The slide switch would allow the officer to activate and deactivate the recorder easily and positively without looking at the device or removing the processing/storage device 203 from its pouch. The slide switch will normally rest in the “stop” position, can slide up into the “record” position to initiate a manual recording, and down into the “stop” position to stop the recording (or other variations incorporating a switching mechanism). Additionally, upon activation, the processing/storage unit 203 or integrated accessory may provide a vibratory notification of a change in status (turned on, turned off, remote activation, etc.).

A number of currently available digital recording devices possess a “soft key” (one push button) to initiate and terminate a recording. This same soft key may be provided to activate and stop the processing/storage device 203. While there can be issues with such a soft key, such a soft key may be provided with the processing/storage device 203.

An officer's holster is integrated into the belt system. When an officer unsnaps the retention device of his handgun holster, this breaks the electrical circuit and activates the system. The officer's processing/storage device 203 activates automatically (with an X second recording buffer). A GPS alert may be sent automatically to a command center notifying them the officer has deployed his handgun and of his/her location using current GPS coordinates or other geographic information regarding location of the processing/storage device 203. Other designated pouches on the officer's belt are also integrated into the belt system. When an officer unsnaps a designated pouch (OC spray, electroshock weapon, baton, handcuffs, etc.), this breaks the electrical circuit and activates the system, again activating the recording function, and a GPS alert is sent to the command center indicating the officer has deployed his OC spray, electroshock weapon, baton or handcuffs and his/her location. Typically pouches or containers for devices linked to risks of liability would be integrated electrically into the system. As an example, drawing a small handheld flashlight from its holster, may not be desired to activate the recording system and may either not be connected to processing/storage device 203 or may not trigger a recording and/or alert to the command center if desired. Additionally, the system may be configured to stream live video to a command center or other officers when activated (for example, an officer drawing her handgun) or the system may be configured so the command center can remotely activate and stream video to the command center for viewing in live time. The processing/storage device 203 may offer play, rewind, and fast forward functionality. These capabilities can be utilized by the officer to review recorded material while still in the field. In some circumstances an officer will record statements from a victim, witness or suspect. He/she may be provided the ability to review these statements so that he/she can prepare an accurate report, subject to the security features discussed above. A simple slide switch can be utilized to initiate these functions, or multiple buttons may be offered. If the processing/storage device 203 has a touch screen, these buttons can be built into the screen software.

The processing/storage device 203 may have a “file” button that can be accessed while the processing/storage device 203 is in its pouch. Once a contact/recording is ended, the officer may invoke the file function to create a new file for the next contact. In this manner, the officer can create an individual date and time stamped file for each contact without removing or looking at the recorder.

If all recordings during an officer's shift are recorded in the same file (recorded material added to the same recorded file as the day went on), such operation could create significant problems. First, it would be extremely difficult to find individually recorded incidents from the officer's shift. The officer would have to manually listen to the recording to find a specific incident. Second, if an arrest was made on the same file as the unrelated incidents, legal representatives of an arrestee may be able to obtain and review unrelated matters. The officer or his supervisors may not be able to “alter the original recording” to only provide the incident of the arrest in question. Creating a separate file for each separate incident/contact, during the officer's shift, creates a recording, which pertains only to the incident in question. Additionally, each file is listed with the date and time the recording was initiated, assisting in the overall management of the recorded incidences.

The processing/storage device 203 or related accessory may provide a “bookmark” button accessible while the processing/storage device 203 is still in its pouch. The purpose of the bookmark feature is so that the officer can “bookmark” a portion of the recording during which significant incidents occur. For example, during the same incident, an officer may bookmark the time when he contacts a victim, when he contacts a witness, and when he interviews a suspect. When the officer prepares his report, he can quickly forward to the bookmarked portion of the recording (when he contacted the victim) and review the recorded statement of the victim. Without the bookmark feature, the officer would have to manually listen to the recording to review specific recorded incidents and interviews.

A folder function may also or alternately be provided to create separate folders for recordings. A folder can be created for each shift so that all recordings for the shift are grouped together, and may be helpful if an officer does not download his recorded material at the end of each shift. In that case, the officer can create a new file for his next shift. Files may be labeled with the date and shift of the officer for easy reference, either automatically or by the officer.

The processing/storage device 203 may have an override or “off” switch that will shut off the recorder in case it is accidentally activated. Although the recorder may have a slide switch to initiate manual recordings, this switch will not slide into the “record” position when the recorder is activated by, for example, a pouch being unsnapped. As such, a means to manually shut off the recorder is provided.

One option to turn off the recording once initiated, by the officer or by critical event, includes an additional button/switch on the processing/storage device 203 to deactivate the recording. A second option is to employ the slide switch to effectuate this operation. The slide switch will normally rest in the “stop” position (e.g. a middle position) and may be repositioned to the “record” position. The slide switch stays in the record or stop position until physically manipulated. The slide switch can also be pushed/slid into an “override off” position that will stop the recorder if activated due to a pouch or holster being unsnapped. The slide switch will not remain in the “override off” position once the officer releases downward pressure. Such a switch may be a momentary switch that automatically slides up into a “stop” position so that it is ready for use. This will prevent the officer from accidentally leaving the switch in the “override off” position and therefore disabling the automatic activation of the recording device when a pouch or holster is unsnapped.

Utilizing the override off switch will stop the recorder from recording based on an automatic trigger (pouch unsnapped). If a pouch remains unsnapped (i.e. handcuffs are removed and used on suspect), the processing/storage device 203 continues to record until the manual override switch is depressed. In that case, the processing/storage device 203 stops recording even though the handcuff case remains unsnapped. The processing/storage device 203 will once again reactivate and record automatically as described if a different pouch is unsnapped, such as the handgun holster. The system may reset automatically or be manually reset once all pouches are re-snapped (i.e. handcuff case is closed again). All activations and deactivations may be recorded and date/time stamped to provide overall management of the system.

The processing/storage device 203 may include a high quality microphone built into the body of the device. The microphone may be positioned on the device to receive an acceptable amount of audio input while worn on the officer's waist. The processing/storage device 203 may further include a display screen, such as an LCD display screen, built into the body of the device and visually providing the officer with information pertaining to files, folders, recorded time, battery power, diagnostic information, etc. The display screen may employ a backlight so that it can be viewed in dark conditions and may be configured so that it is not visible when it is placed in its pouch. The processing/storage device 203 may also include a light indicator, such as a red LED light, in or at the top of the device. The light indicator lights up when the recorder is recording. When the recorder is placed in its pouch, the LED light may be viewed from a direct downward angle by the officer, enabling the officer to visually check to see if the recorder is recording by simply looking down at the recorder pouch.

The processing/storage device 203 may be provided with an audio speaker plug or interface allowing an officer to plug a patch cord, USB or other cord from the recorder to an external speaker, headphones or computer to listen to a recording. The audio speaker plug also allows the officer to plug a patch cord (or similar) from the digital recorder to a conventional analog tape or digital recorder, enabling the officer to make conventional analog tapes to be booked as evidence. The audio speaker plug allows the officer to play back recorded footage at a much louder sound level and with more clarity. This can be utilized when multiple persons are reviewing the recorded footage. Utilizing an external speaker, such as one with its own power source, prevents the digital recorder from utilizing its own power source for playback. The processing/storage device 203 may offer an audio microphone plug in the body of the processing/storage device 203. The microphone plug allows an external microphone to be plugged into the device. Some officers may prefer that a separate microphone be located closer to their face in order to better pick up conversations. This ability will also allow the processing/storage device 203 to be utilized to record audio from preset microphones built into police cars, interview rooms, and so forth. Utilizing a patch cord, USB or similar device is a way to transfer a high quality audio recording from an analog tape recorder to a digital recorder, such as threats recorded on a telephone answering machine). The location of the audio microphone plug may be in a position to allow an external microphone cable to be plugged into the processing/storage device 203 while still inside its pouch.

The processing/storage device 203 is rechargeable with removable batteries, with a battery dependent recording time of average quality video and/or audio recordings, such as an 8 or 12 hour recording time. The processing/storage device 203 may display the power level and indicate the amount of recording time left. The processing/storage device 203 can be recharged by placing it in its charging/download cradle. Rechargeable batteries may be removable so that they may be changed when they are defective of if the officer works longer than the power life of the batteries. Standard sized batteries may be accommodated and may be used as the source of power.

The processing/storage device 203 has the ability to be charged via a cable while still located inside the pouch 210 on the officer's belt. This will allow an officer to plug a charging cable into the system while seated inside his police vehicle, ensuring the system remains fully charged. The processing/storage device will detach from the system when the officer exists his vehicle.

A removable memory medium may be employed with the processing/storage device 203, but a fixed internal memory may also or alternately be used. One memory media that may be employed is that of a “Secure Digital” format (SD card) or similar format. Utilizing removable media enables the officer to download recorded information by removing the SD card and placing it into a computer implemented SD card reader or other reading device. The removable memory card may be placed directly into evidence in an instance of an officer involved shooting. A small access door can be provided in the body of the processing/storage device 203 allowing access to the memory medium. The access door protects the memory card and can be provided with a watertight seal. Alternatively, the processing/storage device 203 may incorporate a non-removable memory medium. This would prevent allegations of tampering with recorded video/audio data.

Recorded material can be downloadable to other media, including but not limited to CD or DVD. The CD or DVD can then be placed into evidence as the original video and/or audio evidence. The recorded format may be compatible with a standard format, such as Windows Media Player and QuickTime. An issue with many current recordings systems is they record in a proprietary format which requires a proprietary software player to playback audio/video. In the public service arena, most computer users do not have administrative rights to their computers and users cannot download proprietary software. Thus a standardized format is generally preferable, but not absolutely required.

The processing/storage device 203 may be provided with anti-tampering functionality, such as anti-tampering software. Such software prevents video and/or audio files from being tampered with, altered or modified whether the recorded incident is on the processing/storage device 203 or if it has been downloaded into a computer. Such technology is widely available. In general, the inability for the officer to erase or alter recordings is provided, with internal components such as time and date stamping of video and/or audio, providing codes to the file and/or footage, identifying critical events or on times for the processing/storage device 203, and recording such information in a location where it cannot be altered or destroyed, and so forth, where a computer user can determine when the recording has been altered or removed.

Other methods include a feature where downloading a video or audio file to removable media such as a CD or DVD causes downloading of a small portion of the software player is downloaded also. Such functionality allows the audio recording to be played by any computer. If the audio file is altered, the audio file no longer functions and the tampering attempt may be logged.

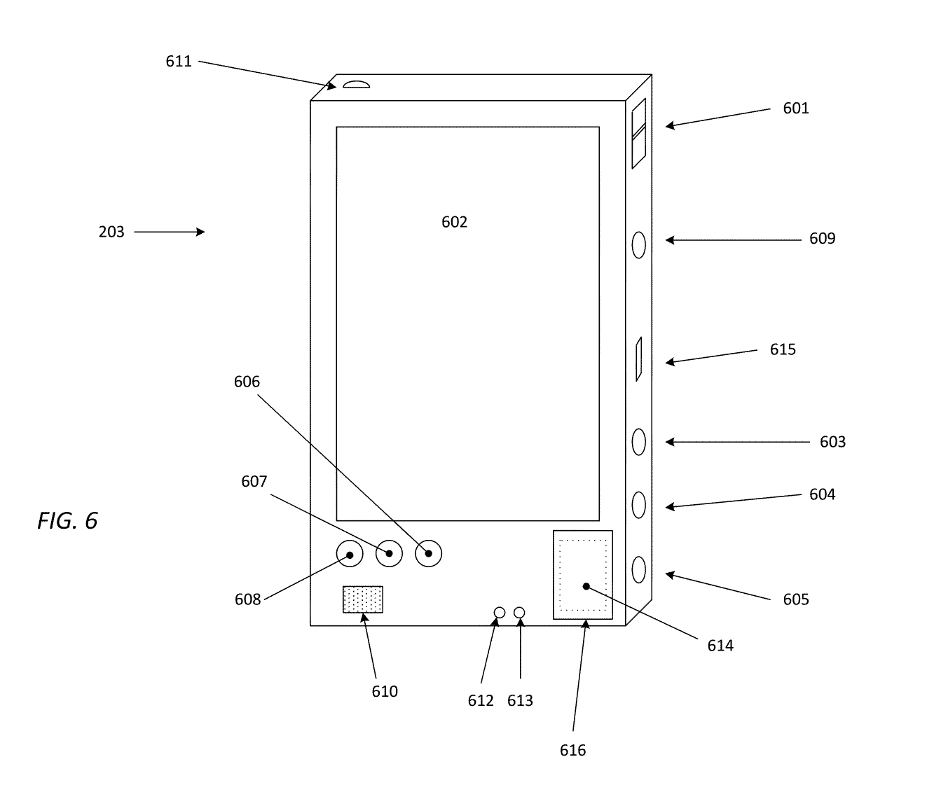

FIG. 6 illustrates one embodiment of a processing/storage device 203, with certain features that may or may not be provided. Slide/activation switch 601 is shown, screen 602, play button 603, rewind button 604, and fast forward button 605, file button 606, bookmark button 607, and folder button 608. As discussed and may be appreciated, buttons may be hardware or software, and any button can be either hardware or software. Off switch 609 is shown, as well as microphone 610, activation light 611, speaker plug 612, microphone plug 613, battery/batteries 614, card slot 615 for an SD card, for example, and access door 616. More, fewer, or different features may be provided. The case or body of processing/storage device 203 may be manufactured from a durable metal or composite. Buttons provided on the processing/storage device 203 can be programmed and reconfigured as desired and may be positioned in any logical manner, including a manner different from that depicted in FIG. 5. A touch screen display may provide additional buttons that can be easily changed and reconfigured based on the agency's needs.

As shown in FIG. 2, a small or miniature video camera or recording device can be plugged into the processing/storage device 203. The camera can be clipped onto the pocket of the officer's shirt, glasses, collar, pocket or any other area, allowing the video camera to capture the viewpoint directly in front of the officer. Alternately, the video camera may be incorporated into the radio handset. Uniformed police officers carry a handheld police radio on their belt, and a handset microphone/speaker may be connected to the radio via a cable. The officer clips the handset onto the V neckline of his/her uniform shirt, enabling the officer to listen to his/her radio and transmit via the handset without removing the handheld radio from its holster on his/her belt. The radio handset is clipped in an acceptable location for a video camera (front center of the officer's body on the neckline of his/her shirt). A small video camera can be incorporated into the radio handset, eliminating the additional cable and camera necessary for the video recorder.

A small video camera, attached via cable to the system, can be clipped onto the existing radio handset issued to officers, providing a simple and secure mounting surface on the officer and ensuring the camera is pointed directly in front of the officer. Different clips may be employed to accommodate various radio handsets. The camera clipping mechanism can be designed as a modular accessory by third party manufacturers. Alternately, a video camera can be mounted onto the belt 201 or built into the processing/storage device 203. Such camera mounting may be for officers not wanting the additional cameras and cabling necessary to attach a camera separate from the system. Alternately, a camera may be clipped onto a pocket or other area of an officer's shirt, attached via a cable to the system. In a military scenario, the officer may have the device attached in another appropriate manner, such as to a helmet or vest.

The processing/storage device 203 may employ an acoustic gunshot activation feature, able to determine a gunshot as a critical event and effectuating the critical event processing described herein. Gunshots have a relatively unique acoustic signature, and processing/storage device 203 can begin recording if a gunshot is detected in the vicinity of the officer. This feature may also notify the police command center with the type of trigger (gunshot detection) and the GPS location of the officer.

Any acoustic sensor can provide false positive readings and triggers. The system may be configured to send a highest priority alert to the police command center if both an acoustic gunshot activation is detected and if the officer's handgun was removed from its holster during the same time period, i.e. within a certain period of time, such as two or five seconds. One example of a gunshot detection device is employed by the U.S. military and is called the Shoulder-Worn Acoustic Targeting System (Ears SWATS), is manufactured by “QinetiQ North America,” deployed on soldiers in Afghanistan. This system not only detects gunshots, but utilizes triangulation technology to designate the direction and potential location of the shooter. Similar functionality may be employed, or a lower level of functionality as desired, such as determining existence of a gunshot in the vicinity.

The system may also incorporate a “protractor” and/or “gyroscope” type functionality in which the processing/storage device 203 or other integrated accessory measures the angle in which the device is currently positioned. Such a function may be used to create a trigger and subsequent GPS notification to a command center in, for example, a situation in which an officer draws his handgun from a holster. The system notifies the command center that a processing/storage device 203 connected to the officer is laying in a 180 degree position suggesting the officer may be laying on the ground. The command center can then dispatch aid to the officer's location.

A diagnostic/self-check feature is employed in processing/storage device 203. This feature can be utilized by the officer in an attempt to ensure the system is functioning properly at the start of each shift. The display screen may inform the officer if the device is functioning properly or if there is a specific problem. The diagnostic feature may check to ensure all circuits on the belt, pouches and holster are functioning properly. A separate light or indicator, such as an LED light can be incorporated into the recorder as a diagnostic test. This indicator may flash or go on when an officer unsnaps each pouch/holster at the start of each shift, show the officer any problem and allowing him to easily identify the problem component, e.g. pouch or holster.

The processing/storage device 203 can optionally be set to maintain a record/log of all recorded incidences which have been erased from the device. The processing/storage device 203 may log and/or transmit the date the original recording was initiated, the time the original recording was initiated, the length of time the original incident was recorded, the time the erased incident stopped recording, the number of times, dates, and/or time the recorded incident was reviewed/listened to before it was erased, whether the incident was downloaded to a computer prior to erasure, the date and time the incident was erased, whether the incident was erased on the digital recorder or from a computer, and if the processing/storage device 203 was checked to see that an incident was erased. Each of these occurrences may be monitored and logged as appropriate and as desired.

Supervisors or administrators of groups of officers may have a dedicated management software tool, installed on police agency computers, which will allow them to track the above listed log entries while the processing/storage device 203 of the officer cannot reveal these contents and the officer cannot alter these contents. If an officer records an incident and then attempts to erase the recording, the administrator may be notified but at the very least will be able to see the erasure attempt. The administrator can then inquire of the officer why he/she erased the incident and/or attempted to erase the incident. The processing/storage device 203 can be configured so that multiple steps are needed to erase a recorded file, tending to decrease the possibility that an incident can accidently be erased. Alternately or additionally, the processing/storage device 203 can be configured so an officer cannot delete any files from the device, preventing inadvertent deletion. The system can be configured so recordings can only be erased by a police administrator after the recordings have been downloaded.

The processing/storage device 203 can be equipped with a lockable memory medium access door. The access door can be unlocked via a special key. Administrators (not individual officers) can be issued a key to open the memory medium access door to prevent tampering by the individual officer and preserve the chain of evidence of the memory medium.

Radio Frequency Identification Devices (RFID) can be provided in the pouches and holsters utilized by the system. This will allow the processing/storage device 203 to identify the types of pouches/holsters attached to the belt 201. The processing/storage device 203 may create a log of the pouch or holster that is used to activate the processing/storage device 203 (including date and time) to indicate what equipment was utilized first (e.g. OC spray, baton, electroshock weapon, handcuffs or handgun). The processing/storage device 203 will also identify subsequent deployments of each item of equipment to provide an accurate time stamped log of the escalation of equipment usage by the officer. For example, the officer may deploy his OC spray and therefore activate the recording system. When the officer deploys his baton, the recording system is already activated and continues recording, the deployment of the baton will cause the log to indicate the time this critical event occurred. The system will also log the officer's deployment of his handgun and eventually handcuffs, including date and time of each of these critical events, all the while recording the situation.

Modern law enforcement vehicles are equipped with Mobile Digital Computer (MDC) systems with wireless capability. The MDC is usually a laptop or trunk mounted computer processor with LCD screen mounted to the dashboard of the vehicle. The MDC transmits/receives data via commercial wireless (cellular air cards). This same MDC has the normal wireless, Wi-Fi and Bluetooth capabilities of most modern laptops. These capabilities may be utilized to interface the belt 201 and system with the computer housed in the police vehicle. This interface may provide additional capabilities and storage redundancies for the system. A similar arrangement may be available and/or employed in the military context, as is true for all of the functionality described herein.

As an example in the law enforcement setting, whenever the officer is within a short distance of his/her vehicle, the system on his/her waist may transmit all recorded media (recorded incidents) to the hard drive of the vehicle's computer. When personnel drive the police vehicle to the police station parking lot (equipped with municipal Wi-Fi/wireless internet), the police vehicle computer wirelessly transmits the recorded material to law enforcement storage servers. Additionally, this function may be replicated via standard commercial wireless that is already in use as a method of data transmission in police cars.

RFID, WiFi, Bluetooth or other wireless technology may be utilized in a hybrid fashion with the system. For example, shotgun and AR-15 rifle locks located in a police vehicle may be connected or configured with RFID/Bluetooth functionality. When the officer unlocks and/or removes a shotgun or rifle from his/her vehicle, the RFID signal sends a trigger to the officer's processing/storage device 203 on his belt 201 to initiate a recording. These represent possible additional critical incidents that may initiate recordings.

### Other Critical Events

The use of a gunshot detector is described above, but other events and/or actions may be used in determining a critical event. For example, an RFID/Wi-Fi/Bluetooth (or other wireless) system could alternately or additionally be connected to the siren and police lighting system of a police car. In this manner, the processing/storage device 203 is activated and begins recording when the police vehicle's lights and siren are activated, such as at the start of a vehicle pursuit. The RFID/Wi-Fi/Bluetooth (or other wireless) system may also or alternately activate the processing/storage device 203 if the officer initiates a traffic stop by activating the solid red light on the police vehicle's police light bar. Alternately or additionally, the system may interface via RFID/Bluetooth to wirelessly connect to crash sensors mounted in the police car. In this embodiment, in the event of a traffic collision (high liability risk event), the car's crash sensors activate and transmit a signal to the system. The processing/storage device 203 then activates, records, and saves the X seconds prior to the collision.

Deployment of other equipment, such as equipment not provided with a duty belt, such as rifles, shotguns, and/or less lethal launchers or other items of equipment may be provided with sensors or electronics that transmit to the processing/storage device, such as wirelessly. The desired apparatus may be equipped with a sensor (associated with or connected to a retention snap, strap, or other retention means) and altering the state of the retention snap, strap, or other retention means causes a signal to be transmitted to processing/storage device 203. Deployment of a particular weapon or device, such as a device normally located in an officer vehicle, may also or alternately activate the processing/recording device 203 to begin recording as described herein, and may provide streaming video to a remote location, such as the command center, and may provide associated GPS coordinates. WiFi may be incorporated into or with the weapon or device to provide wireless connectivity to the processing/storage device 203 and wireless technologies (Wifi, RFID, Bluetooth or other) may be used to integrate the belt system and processing/storage device 203 into desired assets of a police vehicle or its equipment.

Additionally, police officers utilize a handheld police radio in the performance of their duties. The radio is placed inside a radio pouch, which may additionally be attached to the present system. If the radio's emergency trigger switch (E-trig) is activated, this can also activate the processing/storage device 203.

The inside bottom of the radio pouch may include a radio interface that matches the radio. When the radio is slid into the radio pouch, the radio joins to the present system. An alternate approach is to provide a different radio handset interface which incorporates connectivity with the present system, enabling recording of audio transmissions or uses of the police radio.

Existing handheld police radios now have the option of incorporating GPS (Global Positioning System) information. When the radio's “emergency trigger switch” (E-Trig) is activated by an officer, an “emergency” signal and the officer's location is automatically transmitted, by the radio, to a command center. This provides the officer with an immediate police backup response when he/she does not have time, ability, or presence of mind to request assistance verbally, such as when the officer is involved in a fight. This option can be added to existing police radios by incorporating a new handset with an embedded GPS receiver or other accessory.

A significant issue with the existing police radio and integrated GPS system is that officers in escalating situations often do not have time to activate the emergency trigger of their radio to transmit the GPS signal and location. The “Achilles' heel” to existing GPS technology is the need for the officer to consciously initiate an administrative action, such as pushing a radio button, prior to taking law enforcement action. For example, an officer involved in a shooting is generally too busy drawing and firing his/her handgun to push a button on his radio until after the incident is over. GPS transmission to the police command center is preferably immediate and automatic.

When the police radio (with GPS technology) is integrated into the present system, the officer's level of safety increases significantly while potentially reducing liability. An officer deploying his OC spray, electroshock weapon, baton or handgun, activates the processing/storage device 203 and may send an alert to the command center, via the integrated police radio, notifying the command center of the officer's GPS location. This GPS alert may indicate the item deployed from the officer's belt 201. The command center can then deploy additional police units to assist the officer and/or attempt to contact the officer via radio for his/her status. Such functionality may be accomplished via the integration of commercial wireless (cellular) into the system. The commercial wireless can be a back-up system to the integrated radio/GPS system or can act as a free standing system.

If the officer attempts to make an arrest, he/she will unsnap the pouch or retention device holding his/her handcuffs, activating the processing/storage device 203 and possibly sending an alert to the command center that the officer's handcuffs have been removed and his/her GPS location. The command center may dispatch “back-up” police units and/or a supervisor to the officer's location without oral request by the officer. Such functionality provides an increase in officer safety. In this configuration, the officer's radio or processing/recording device 203 (via commercial wireless or other method) may only send GPS coordinates to the command center when the officer is about to make an arrest, utilize significant force, or draw his/her handgun, where each event triggers the recording using the processing/storage device 203. In all of these cases, the officer will likely want the command center to be notified of his/her location so back up officers can respond.

The system can be tailored so that only specific pouches/holsters activate the GPS alert to the command center. For example, agencies may require that a GPS alert only be sent to their command center when an officer removes his handgun from its holster. Other agencies may require such alert no matter which item is removed from the officer's belt. The processing/storage device 203 is able to identify the type of pouch or holster which has been unsnapped, the retention system disabled, and/or which police item was deployed, such as by sensing altered voltage or current on the wire connecting the handgun holster, for example, to the processing/storage device 203. This information may then be transmitted to the police command center via the police radio or commercial wireless (or similar technology) incorporated into the system. The command center will then know which one of the officer's police devices has been deployed. If the officer deploys/unholsters his/her handgun, the command center may deploy resources differently than if the officer deploys his/her handcuffs. As an example, this specific notification feature may be beneficial if an officer unholsters his/her handgun and the processing/storage device 203 detects the acoustic signature of a gunshot. Such a scenario may indicate to the command center that the officer is in an officer involved shooting and the command center may receive the officer's GPS location.

It would be beneficial if the officer knew every instance when he or she was recording using the present system. Recording could be inadvertently initiated, which is undesirable. The system may notify the officer in some manner each and every time the recording device is activated. Audible tones or beeps or light flashing may be employed, but these may not be desired. Alternately, a small vibratory device may be attached to or provided with the system. Such a vibratory device may be separately powered and provide a one second vibration alert any time a pouch or holster is unsnapped, producing a vibratory alert similar to that provided by a cell phone. The vibrating may be turned off manually or when the recording is stopped. The vibratory alert may be used as a signal for a variety of functions including but not limited to the device being activated, the device being turned off, low battery notification, etc.

When an officer unsnaps a pouch integrated into the present system or otherwise encounters or acts to perform a critical event, the officer may feel a vibration alert on his belt for a certain duration, such as one second. This vibration notifies the officer that the processing/storage device 203 has been activated and has started recording X seconds prior to activation based on the X second recording buffer feature.

The vibratory alert may not be incorporated into the processing/storage device 203 as this would increase the size of the device, waste processing/storage device power, and may cause recording interference issues when the vibratory alert is sent. Vibration strength may be adjustable so that the officer feels the device vibrating on his/her belt (notifying him/her the recorder is on) but vibrates at a level not so great that the vibration becomes distracting. The purpose of this option is to ensure an officer is notified when the processing/storage device 203 is actively recording if a pouch is accidently unsnapped. As an option, this function may not be integrated into the handgun holster of the system, as it is generally unlikely the officer would not know the holster on his/her handgun has been unsnapped. Not integrating the handgun holster into the vibratory alert option may ensure the officer is not distracted by a vibration on his/her belt if involved in an on-duty shooting. The vibratory alert may be provided as a “reminder feature” of the system. In this case, the officer may receive a one second vibratory notification every Z minutes (any predetermined time period) to inform him/her the system was still recording. When an officer deploys equipment for relatively long periods of time, such as handcuffing a suspect and taking the suspect to jail, the officer's integrated handcuff case may be unsnapped for an extended period of time, such as over an hour, triggering the system and recording for the entire time period. The vibratory alert may notify the officer of the recording, at which time the officer could elect to turn the recording off when no longer necessary.

An override switch, such as at a command center, may be provided and/or employed. Whenever an officer unsnaps a system pouch (OC Spray, electroshock weapon, baton, handcuffs, etc.) or his handgun holster, the integrated GPS radio or commercial wireless may transmit an alert to the command center. This may produce a false command center notification if the officer accidentally unsnaps a pouch, unholsters his handgun prior to entering a restricted custody facility, removes his equipment at shift change, etc. The system may provide a Q second delay from the time the officer unsnaps a pouch or unholsters his handgun until the integrated GPS radio sends an alert to the command center. During this Q second interval, the officer has time to push an alert override button or switch built into the vibratory notification device or processing/storage device 203. The override button/switch may be built into the vibratory device so the officer will feel the device vibrate when activated. Alternately the functionality may be provided with the processing/storage device 203. This function may cancel the GPS alert to the command center but may still activate the recording device. A situation where this may be applicable is if an officer deploys his handcuffs at an incident where numerous other officers are already present. The officer may wish to record the incident but may not want to alert the command center in manner in which it is believed the officer is requesting assistance.

The command center alert override button/switch may prevent the command center from receiving numerous false activations each shift. The command center can then initiate an appropriate response when an officer unholsters his handgun and be fairly certain that the officer needs assistance.

If an officer unsnaps his/her handgun holster, the system may activate the processing/storage device 203 located on his/her belt, may initiate a vibratory alert to notify the officer the processing/storage device 203 has been activated and is recording video and/or audio, and send an alert to the command center (within Q seconds) that the officer has deployed his/her handgun, including the GPS coordinates of the officer. The command center may attempt to contact the officer via his/her handheld radio to ascertain if he/she needs assistance from additional police officers. If the officer does not respond, the command center can immediately dispatch additional police units to ascertain the condition of the officer.

The processing/storage device 203 can be manufactured with a retractable USB plug built into the body of the device, allowing the processing/storage device 203 to possess the ability to provide or download information to almost any computer. Other common interface capability may be provided. A docking cradle may be provided to download recorded files to a computer and recharge the recorder at the same time. Officers equipped with the present system may, at the end of a shift, place their processing/storage devices 203 on a docking cradle (not shown) in a supervisor's office, and the docking cradle could be used to download all recorded material. The digital recorder software could be set up to automatically track which officers have downloaded their recordings from each shift. This would make it simple for police administrators to identify which officers have not downloaded their recorded material and for which shift. Many current law enforcement sites, such as police stations, include secure wireless (generally Wi-Fi) “hot spots” that laptops and mobile devices can access to connect to the internet or law enforcement infrastructure. The law enforcement “hot spots” normally encompass the interior of the police station, parking lot and exterior. In one embodiment, when a processing/storage device 203 enters the Wi-Fi coverage of a law enforcement station, a wireless connection may occur, authentication provided, and date and time may be synchronized. In certain instances, the download process of recorded media may commence. A wireless connection, e.g. a Wi-Fi connection, may simplify the process of downloading video and audio recordings from the processing/storage device 203 to police station servers. When an officer enters the station area, his/her processing/storage device 203 may connect to the wireless network and wirelessly download all recorded information into the station servers. No interaction is required from the officer. A similar method has been utilized by in-patrol car video systems.

The processing/storage device 203 may incorporate an LCD type screen to provide information, configuration options and enable review of recorded media. The LCD screen may function similar to that of a smartphone. The officer may connect the device to any computer, such as a mobile digital computer inside a police vehicle, in order to review previously recorded data. The system may have the capability of pushing out recorded media to a computer via wired (e.g. USB, HDMI, etc.) or wireless interfaces (Wi-Fi, Bluetooth, etc.). The system may have inherent safety features that do not allow an end user to manipulate or modify recorded data on the device but merely view such data. Additionally, software may be incorporated which will not allow the export of the recorded data to a computer unless predesignated by an administrator to ensure evidentiary video and data are not disseminated without the express approval of the police agency.

When an officer employing the present system deploys an item of police equipment, the system activates the processing/storage device 203 and may transmit a GPS alert notification to a command center. This arrangement can lead to false activations while officers are, for example, in the police station. The officers could be changing clothes, removing equipment or cleaning their firearms, for example. An optional embodiment of the system entails the GPS alert notification feature being deactivated when the officer is at the station within the zone of, for example, a police station Wi-Fi hotspot. The likelihood is extremely low the officer would be involved in significant use of force, an officer involved shooting or making an arrest in the station area. If such an event took place, numerous other officers would be on hand to lend assistance, and in-station cameras are at times employed to record such events in areas of the station traveled by civilians. When an officer employing the system leaves the area, e.g. Wi-Fi hotspot, the system senses the signal drop and may reactivate the GPS Alert Notification feature. Such reactivation may ensure the officer's location is dispensed to the police command center whenever the officer is involved in law enforcement action in the field. This type of process is generally referred to as a “Geo Fence” and is defined by an administrator for use by officers and appropriate equipment and devices.

Geo Fence capabilities of the system can also include the ability to automatically activate the device when the wearer is physically present in specific areas. For example, the system could automatically activate the recording system and notify the command center whenever the officer enters an area which has been known to be dangerous (high crime or gang area) or where there is a significant risk of complaints. The latter example would include a call for service to a home in which the owner has repeatedly made false allegations against law enforcement. In such a case, the system automatically triggers and activates once the officer enters the Geo Fence area around that physical location.

The system may incorporate various biometric sensors and readers to monitor the various medical attributes of the system user to include, but limited to, heartbeat sensor, pulse, blood pressure, perspiration, voice analysis, etc. Sensors may be incorporated into the processing/storage device 203, camera, pouches, etc. or any variety of items provided. Additionally, sensors may be integrated into an officer's bullet resistant vest, shoes, helmet, hat, clothing, etc. and be connected via hard wiring or wireless methodologies to the system, such as processing/storage device 203. The system monitors these sensors, and may employ, synchronize and/or provide relevant information gathered into recorded video/audio data. Additionally, this sensed information can be transmitted automatically via commercial wireless, Wi-Fi, Bluetooth or other wireless methods to a police command center, which may for example monitor the health and stress of the officer using the system in the field. The system could transmit an officer's location, turn on the recording device, and transmit live video to the command center if the officer's heartbeat elevates to 50% over his normal baseline heartbeat level, for example.

Transmissions and communications may be made from and to processing/storage device 203 using commonly available systems, including commercial wireless cellular, Wi-Fi, Bluetooth, and so forth.

Thus various events, signals, information, or data may be transmitted on a wireless network to a remote location, including but not limited to a vibration alert indicating the belt has activated one or more functions or devices, the location of the belt (GPS location), occurrence of a critical event thus initiating recording beginning at a prior point in time, with past video/audio and ongoing video/audio preserved, and video and/or audio transmission to a remote location (police dispatch, supervisor's computer, etc.)

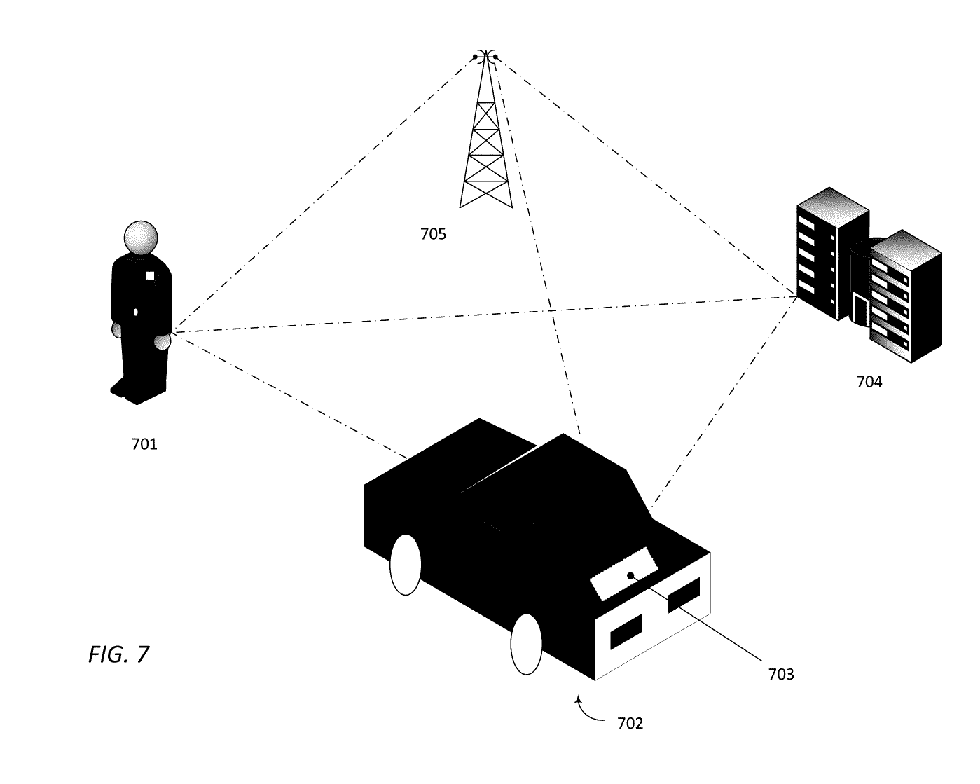

FIG. 7 illustrates a conceptual arrangement when an officer is employing the present system. Officer 701 may remove a device from a pouch on her belt, determined as a critical event by her processing/recording device 203 (not shown in this view). Processing/recording device in this instance marks the continuously recording video and audio at a predetermined time before the device was removed. In this scenario, the processing/recording device may provide an indication of a critical event to a computing device 702 in vehicle 703 which may then provide the critical indication to command center 704, may provide the critical event indication to a cell tower 705 that provides the indication to command center 704, or the processing/recording device 702 may provide the critical event indication directly to command center 704. The incident may proceed to a conclusion, at which time officer 701 turns off processing/recording device 701. In this scenario, the storage capacity of processing/recording device 701 is sufficient to hold additional audio and video, and thus the processing/recording device 203 marked the point where the recording was stopped by the officer, begins recording new ongoing video while not recording over the existing video and/or audio of the incident commencing with the critical event.

At this point, the system may transmit the recorded video in any manner shown if available, such as to the computing device 702 in vehicle 703, and from computing device 702 to command center 704, optionally using cell tower 705, or directly to the command center 704. Alternately, the processing/recording device 203 may hold the audio and/or video recording and may download it at a desired location, such as at a police station, barracks, or control center such as command center 704. This again represents one scenario, and other scenarios are possible, such as the officer driving her vehicle into range of a Wi-Fi hotspot wherein the processing/recording device and the Wi-Fi hotspot are configured to download the recording or recordings to a central server system or network.

Thus according to the present design, there is provided a recording apparatus, including a recording device configured to continuously record audio and/or video, thereby providing an audio and/or video recording, and a belt provided with a plurality of receptacles, each receptacle provided with the belt configured to hold a device, wherein the plurality of receptacles are electrically connected to the recording device. Altering status of one device in one receptacle provided with the belt causes an indication to be transmitted to the recording device, and wherein upon receiving the indication the recording device is configured to establish a prior point in time of the audio and/or video recording as a beginning of a critical event and preserve recorded audio and/or video from the beginning of the critical event to an end recording point.

According to another aspect of the present design, there is provided a recording apparatus, including a belt provided with a plurality of receptacles, each receptacle provided with the belt configured to hold a device comprising at least one from the group comprising a law enforcement device, a security device, and a military device, and a recording device configured to receive signals from the plurality of receptacles, the recording device configured to continuously record audio and/or video, thereby providing an audio and/or video recording. Altering status of one device in one receptacle provided with the belt causes a critical event indication to be sensed by the recording device, and wherein based on the critical event indication the recording device is configured to establish a prior point in time of the audio and/or video recording as a beginning of a critical event and preserve recorded audio and/or video from the beginning of the critical event to an end recording point.

According to a further aspect of the present design, there is provided a law enforcement belt system, including a belt maintaining a plurality of receptacles, each receptacle configured to hold a law enforcement device, and a recording device configured to receive signals from the plurality of receptacles, the recording device configured to continuously record audio and/or video, thereby providing an audio and/or video recording. Removal of one law enforcement device from one receptacle provides a signal to the recording device interpreted by the recording device as a critical event indication, and wherein based on the critical event indication the recording device is configured to establish a prior point in time of the audio and/or video recording as a beginning of a critical event and preserve recorded audio and/or video from the beginning of the critical event to an end recording point.

The previous description of the disclosure is provided to enable any person skilled in the art to make or use the disclosure. Various modifications to the disclosure will be readily apparent to those skilled in the art, and the generic principles defined herein may be applied to other variations without departing from the scope of the disclosure. Thus, the disclosure is not intended to be limited to the examples and designs described herein but is to be accorded the widest scope consistent with the principles and novel features disclosed herein.

What is claimed is:

1. A recording apparatus, comprising:
a recording device configured to continuously record audio and/or video, thereby providing an audio and/or video recording; and
a belt provided with a plurality of receptacles, each receptacle provided with the belt configured to hold a device, wherein the plurality of receptacles are electrically connected to the recording device;
wherein altering status of one device in one receptacle provided with the belt causes an indication to be transmitted to the recording device, and wherein upon receiving the indication the recording device is configured to establish a prior point in time of the audio and/or video recording as a beginning of a critical event and preserve recorded audio and/or video from the beginning of the critical event to an end recording point.

2. The recording apparatus of claim 1, wherein each of the plurality of receptacles is provided with a different wire facilitating an electronic connection to the recording device.

3. The recording apparatus of claim 1, wherein:
a first device comprises a handgun and a first receptacle comprises a holster; and
a second device comprises a critical event triggering device and a second receptacle comprises a pouch provided with the belt, wherein altering status of the pouch causes the recording device to establish the prior point in time of the audio and/or video recording as the beginning of the critical event and preserve recorded audio and/or video from the beginning of the critical event to the end recording point.

4. The recording apparatus of claim 1, wherein the recording apparatus employs a device configured to determine an occurrence of a critical event separate from removing one device from one receptacle.

5. The recording apparatus of claim 1, wherein the recording device is configured to provide a tamper-resistant indicator with the recorded audio and/or video that cannot be altered by a user of the recording device.

6. The recording apparatus of claim 1, wherein the belt is configured for use by one individual from the group consisting of a law enforcement officer, a security officer, a military solider.

7. The recording apparatus of claim 1, further comprising an audio and/or video sensor configured to provide audio and/or video signals to the recording device and configured to be mounted on a person's outer garments and/or equipment.

8. The recording apparatus of claim 1, wherein the recording apparatus comprises a switch configured to stop recording audio and/or video when desired by a user.

9. The recording apparatus of claim 1, wherein upon receiving the indication of the critical event, the recording device is configured to transmit the critical event indication to a remote device.

10. A recording apparatus, comprising:
a belt provided with a plurality of receptacles, each receptacle provided with the belt configured to hold a device comprising at least one from the group comprising a law enforcement device, a security device, and a military device; and
a recording device configured to receive signals from the plurality of receptacles, the recording device configured to continuously record audio and/or video, thereby providing an audio and/or video recording;
wherein altering status of one device in one receptacle provided with the belt causes a critical event indication to be sensed by the recording device, and wherein based on the critical event indication the recording device is configured to establish a prior point in time of the audio and/or video recording as a beginning of a critical event and preserve recorded audio and/or video from the beginning of the critical event to an end recording point.

11. The recording apparatus of claim 10, wherein each of the plurality of receptacles is provided with a different wire facilitating an electronic connection to the recording device.

12. The recording apparatus of claim 10, wherein:
a first device comprises a handgun and a first receptacle comprises a holster; and
a second device comprises a critical event triggering device and a second receptacle comprises a pouch provided with the belt, wherein altering state of a retention device provided with the pouch causes the recording device to establish the prior point in time of the audio and/or video recording as the beginning of the critical event and preserve recorded audio and/or video from the beginning of the critical event to the end recording point.

13. The recording apparatus of claim 10, wherein the recording apparatus employs a device configured to determine an occurrence of a critical event separate from removing one device from one receptacle.

14. The recording apparatus of claim 10, wherein the recording device is configured to provide a tamper-resistant indicator with the recorded audio and/or video that cannot be altered by a user of the recording device.

15. The recording apparatus of claim 10, wherein the belt is configured for use by one from the group comprising a law enforcement officer, a security officer, and a military solider

16. The recording apparatus of claim 10, further comprising an audio and/or video sensor configured to provide audio and/or video signals to the recording device and configured to be mounted on a person's outer garments and/or equipment.

17. The recording apparatus of claim 10, wherein the recording apparatus comprises a switch configured to stop recording audio and/or video when desired by a user.

18. The recording apparatus of claim 10, wherein upon receiving the indication of the critical event, the recording device is configured to transmit the critical event indication to a remote device.

19. A law enforcement belt system, comprising:
a belt maintaining a plurality of receptacles, each receptacle configured to hold a law enforcement device; and
a recording device configured to receive signals from the plurality of receptacles, the recording device configured to continuously record audio and/or video, thereby providing an audio and/or video recording;
wherein removal of one law enforcement device from one receptacle provides a signal to the recording device interpreted by the recording device as a critical event indication, and wherein based on the critical event indication the recording device is configured to establish a prior point in time of the audio and/or video recording as a beginning of a critical event and preserve recorded audio and/or video from the beginning of the critical event to an end recording point.

20. The law enforcement belt system of claim 19, wherein the end recording point occurs when a using officer manually terminates the video recording.

21. The law enforcement belt system of claim 19, wherein the system employs wireless technology to transmit a GPS location and stream video/audio to a remote location in real time.
